(19) United States
(12) Patent Application Publication
(10) Pub. No.: US 2010/0281077 A1
(43) Pub. Date: Nov. 4, 2010

(54) BATCHING REQUESTS FOR ACCESSING DIFFERENTIAL DATA STORES

(76) Inventors: Mark David Lillibridge, Mountain View, CA (US); Kave Eshghi, Los Altos, CA (US); Vinay Deolalikar, Cupertino, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/432,804

(22) Filed: Apr. 30, 2009

(51) Int. Cl. G06F 17/30

(52) U.S. Cl. 707/812; 707/E17.032; 709/247; 709/238

(57) ABSTRACT

Data objects are selectively stored across a plurality of differential data stores, where selection of the differential data stores for storing respective data objects is according to a criterion relating to compression of the data objects in each of the data stores, and where the differential data stores are stored in persistent storage media. Plural requests for accessing the differential data stores are batched, and one of the differential data stores is selected to page into temporary storage from the persistent storage media. The batched plural requests for accessing the selected differential data store that has been paged into the temporary storage are executed.

### CROSS-REFERENCE TO RELATED APPLICATION

This is related to U.S. patent application Ser. No. 11/411,386, entitled “Distributed Differential Store With Non-Distributed Objects And Compression-Enhancing Data-Object Routing,” filed Apr. 25, 2006, U.S. Patent Publication No. 2007/0250519, which is hereby incorporated by reference.

### BACKGROUND

As capabilities of computer systems have increased, the amount of data that is generated and computationally managed in enterprises (companies, educational organizations, government agencies, and so forth) has rapidly increased. Data may be in the form of emails received by employees of the enterprises, where emails can often include relatively large attachments. Moreover, computer users routinely generate large numbers of files such as text documents, multimedia presentations, and other types of data objects that have to be stored and managed.

Data management performed by an enterprise includes data backup, where certain data in the enterprise is copied to backup storage systems to protect the integrity of the data in case of failures or faults. Another form of data management is data archiving, wherein some subset of data is moved to separate storage systems. However, storing large amounts of data is associated with various costs, including storage media costs, power and cooling costs, and management costs.

### BRIEF DESCRIPTION OF THE DRAWINGS

Some embodiments of the invention are described with respect to the following figures:

FIG. 1 is a block diagram of an exemplary network arrangement in which an embodiment of the invention can be incorporated;

FIG. 2 is a flow diagram of processing requests according to an embodiment; and

FIG. 3 is a flow diagram of processing requests according to another embodiment.

### DETAILED DESCRIPTION

Large amounts of data may be stored by an enterprise for various purposes, such as for data backup or data archiving. To enhance the efficiency of storing data, differential data stores can be used.

Traditional data stores are non-differential: the amount of space they use to store a set of objects does not depend on how different the objects are from each other. For example, the space used by a traditional store to store the set of objects {O₁, O₂, . . . Oₙ} is typically M+f(Oₗ)+f(O₂)+ . . . +f(Oₙ) for some constant M and function f. (If per-object compression is not used, f(Oᵢ) is the size of object i, possibly rounded up to a block boundary; otherwise, f(Oᵢ) is the size of the compressed version of Oᵢ). Note in particular that the space used does not depend on how much object Oᵢ differs from another Oⱼ.

Differential data stores, by contrast, are defined to be data stores that use less space the greater the similarity among the set of objects to be stored. They accomplish this, in general, by frequently storing only the differences between objects rather than a complete copy of each one. Consider, for example, the addition of a new multiple-megabyte object that differs only in its first few bytes from an object already in the store it is being added to. If the store is a differential store, then the addition should consume only a few hundred to a few thousand more bytes of space; on the other hand, if the store was non-differential, then the addition will consume megabytes. Note that merely storing only one copy of each object (e.g., storing an identical copy of an existing object consumes little or no additional space) does not by itself make a store differential: a differential store is a store that uses less space the more similar two or more different objects are to each other.

Building relatively large differential data stores can pose various challenges. One such challenge is that the amount of relatively high-speed memory (typically implemented with random access memory devices) can be relatively small when compared to the size of persistent storage media such as disk drives. If differential data stores are not designed properly, then efficiency can be lost if there exist excessive input/output (I/O) accesses of the relatively slow persistent storage media for performing various operations (e.g., read, write, etc.) with respect to data objects stored in the differential data stores.

In accordance with some embodiments, a system or technique is provided that selectively stores data objects across multiple differential data stores, where selection of the differential data stores for storing respective data objects is according to a criterion relating to compression of the data objects in each of the data stores. Each of the differential data stores is implemented as a subcomponent of a storage system. Any implementation can be used for the differential data stores, including possibly different implementations for different differential data stores. In some embodiments, it is assumed that a given differential data store is made up of software code (referred to as “differential data store code”) and data (referred to as “differential data store data”), wherein the data may be further split into frequently-accessed data and infrequently-accessed data. It may be further assumed that to perform operations accessing a data store with reasonable efficiency, it suffices to load that differential data store's frequently-accessed data into fast temporary storage (which can be implemented with memory devices such as dynamic random access memories, static random access memories, and so forth).

According to some embodiments, such a process of loading the differential data store's frequently-accessed data is referred to as paging in the differential data store. In some embodiments, paging may involve loading the entire differential data store's frequently-accessed data into fast temporary storage. In other embodiments, paging may involve loading the entire differential data store's data (both frequently-accessed data and infrequently-accessed data) or just part of the data store's frequently-accessed data initially, with more of that data to be loaded later on demand.

The differential data stores' data is stored in a persistent storage, which can be implemented with disk-based storage media (magnetic or optical disk-based storage media), or other type of storage media. In accordance with some embodiments, to improve operational efficiency, requests for accessing the differential data stores are batched, and one of the differential data stores is selected to page in from the persistent storage to the temporary storage. Batching requests refers to collecting multiple requests for execution together. The batched requests for accessing the selected differential data store that has been paged into the temporary storage are then executed.

Using techniques according to some embodiments, greater speed is achieved when performing requests with respect to the differential data stores. By batching multiple requests and executing the batch of requests for accessing the differential data store that has been paged into the temporary storage, the number of times that any differential data store's data has to be swapped between the persistent storage and the temporary storage (a process referred to as “paging”) for processing the requests is reduced. Reducing the amount of paging between the persistent storage and the temporary storage reduces the number of relatively slow input/output (I/O) cycles that have to be performed to execute the requests, which leads to improved system performance.

A “data object” refers to any assembly of data, such as a file, a text document, an image, a video object, an audio object, any portion of any of the foregoing, or any other object. A “data store” refers to a logical collection of data (which can include multiple data objects) that can be stored in a physical storage system. In some embodiments, multiple data stores can be provided in one physical storage system. In an environment with multiple physical storage systems, each of the physical storage systems can include one or multiple data stores.

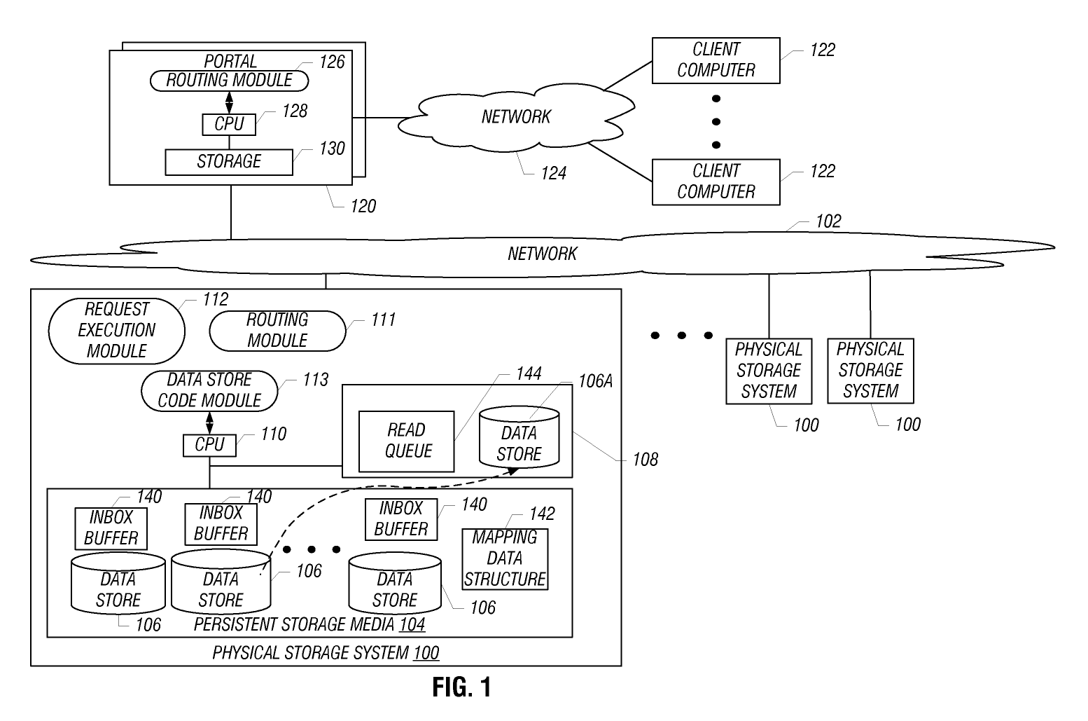

FIG. 1 illustrates an exemplary distributed differential data store system that includes multiple physical storage systems 100 that are connected to a network 102. The network 102 can be a local area network (LAN), storage area network (SAN), or other type of network. In a different implementation, techniques according to some embodiments can be performed with just one physical storage system 100, rather than plural physical storage systems.

FIG. 1 depicts components within one of the physical storage systems 100. The other physical storage systems 100 can include the same or similar components. Each physical storage system 100 includes persistent storage media 104, which refer to storage media that are able to maintain the data stored on such storage media even in the absence of main power in the physical storage system 100. Examples of the persistent storage media 104 include disk-based storage media such as magnetic disk-based storage media, optical disk-based storage media, flash memory, and so forth.

The physical storage system 100 also includes temporary storage 108. The temporary storage 108 is made of one or more storage devices that are designed to temporarily store data contained in the persistent storage media 104. Examples of the temporary storage 108 include dynamic random access memories (DRAMs), static random access memories (SRAMs), and so forth.

The physical storage system 100 also includes one or more central processing units (CPUs) 110 that is (are) connected to the persistent storage media 104 and the temporary storage 108.

Multiple differential data stores 106 (each data store 106 represents a differential data store's data) can be stored on the persistent storage media 104 in each physical storage system 100. Note that the code portions of the data stores 106 are represented by the data store code module 113. In the ensuing discussion, reference to a “differential data store” or a “data store” is usually intended to refer to the data or the paged data of the data store. Each data store 106 is configured to have a size that is small enough such that the data store 106 can be fully paged into the temporary storage 108. In other words, in embodiments where paging in a data store 106 means loading only its frequently-accessed data, the size of each data store 106 is configured so that all of its frequently-accessed data uses less than the available space in the temporary storage 108 that is allocated for storing a data store. In embodiments where paging in a data store 106 means loading in all its data, the size of each data store 106 is configured so that all of its data uses less than the available space in the temporary storage 108 that is allocated for storing a data store.

Various software modules are executable on the CPU(s) 110. The software modules include a request execution module 112 to control execution of requests received by the physical storage system. The request execution module 112 is also able to control the paging of data stores 106 between the persistent storage media 104 and the temporary storage 108. As indicated by a dashed line 114 in FIG. 1, one of the data stores 106 is currently paged into the temporary storage 108. The data store paged into the temporary storage 108 is represented as 106A. As discussed above, 106A may be only a subset of the data of the data store 106 that has been paged in.

Requests (e.g., write requests, read requests, delete requests, and/or other requests) received by the physical storage system 100 are batched by the request execution module 112, and the batched requests for accessing the data store 106A are then executed. Requests received by the physical storage system 100 can be collected into multiple batches, where each batch of requests corresponds to a particular one of the data stores 106. Performing a batch of requests with respect to the corresponding data store 106A paged into temporary storage 108 enhances efficiency, since the data store 106A has to be paged between the persistent storage media 104 and temporary storage 108 just once to perform the requests in the corresponding batch. This is contrasted with implementations where the requests are processed in sequence as they are received, which can cause one or more of the data stores to be paged between the persistent storage media 104 and temporary storage 108 more than once.

It is noted that an incoming request can be for accessing a data store because that data store is where the data object referred to by the incoming request is stored or will be routed. The incoming request does not have to specify the specific data store. For example, a write request can include an update request (to modify an existing data object in a data store) or a store request (to insert a new data object into the system). The update request will (possibly indirectly) specify the data store to which the update request is to be routed, while the store request will not specify any data store, but instead will be routed to an appropriate data store by a routing algorithm.

The software modules in each physical storage system 100 further include a routing module 111 to route data objects to selected ones of the data stores 106 for storage. The routing module 111 implements a routing algorithm that is designed to enhance compression of data objects stored in each of the data stores 106. Such a routing algorithm is referred to as a “compression-enhancing routing algorithm.” In some embodiments, using the compression-enhancing routing algorithm increases the degree of relevant similarity between data objects stored in each of the data stores 106. By increasing the degree of similarity among data objects stored in any particular data store 106, a higher degree of compression can be achieved. Data objects are considered to be similar based on sharing of some amount of common data. Data objects that share some amount of common data are compressible when stored together in a data store. Generally, a differential data store is able to store similar data objects A1, A2, and A3 in less data storage space than a sum of the data storage space that would have to be provided to individually store the data objects, A1, A2, and A3 in their entirety.

Consider, for example, the list of data objects [A, a, b, B, a, c, C] where the only data objects that are similar are those with the same letter. A random routing of these objects to three differential data stores 106 may divide the data objects among the differential data stores as [a, B], [A, B, b], and [a, c, C]. On the other hand, a compression-enhancing routing algorithm would divide the data objects as follows: [a, A], [b, B], and [c, C], which enhances the compression of the data objects in each of the differential data stores since similar data objects are routed to the same differential data store.

Generally, a compression-enhancing routing algorithm maps data objects that are similar according to a particular metric to the same destination (same differential data store 106). Examples of compression-enhancing routing algorithms are described in U.S. Patent Publication 2007/0250519, and in U.S. Pat. No. 7,269,689.

Another software module in each physical storage system 100 is the data store code module 113, which contains the code for the differential data stores 106. The data store code module 113 may perform deduplication. Deduplication of data objects refers to avoiding storage of common portions of data objects in the data stores. In some embodiments, the deduplication of data objects is accomplished based on partitioning data objects into non-overlapping chunks. A “chunk” refers to an element of a partition of input data, where the input data can be in the form of a file or other data object. As examples, the input data can be a document (such as a document produced or edited by a software application), an image file, a video file, an audio file, a tape image, or any other collection or sequence of data. By dividing one or more data objects into chunks, a system is able to identify chunks that are shared by more than one data object or occur multiple times in the same data object, such that these shared chunks are stored just once to avoid or reduce the likelihood of storing duplicate data. If chunking is used, then the differential data stores are considered chunk-based differential data stores.

One type of chunking algorithm is a landmark chunking algorithm, which performs partitioning of one or more data objects by first locating landmarks present in the one or more data objects. The landmarks are short predefined patterns of data whose locations are used in determining chunk boundaries. Landmarks are defined based on local content of the input data. For example, one technique of locating landmarks is to use a sliding window algorithm where, for each position within the input data, a fingerprint is computed for the sequence of data within the respective sliding window. The sliding window contains bytes within the input data that precedes the position of the input data being considered. If the computed fingerprint satisfies a particular criterion, the position is designated as a landmark. In one specific example, a position in the input file is a landmark if the immediately preceding 48 bytes (sliding window) have a Rabin fingerprint equal to −1 mod a predefined number related to the average desired chunk size. In other implementations, other fingerprints or other values computed from other functions can be computed based on the content of the input data. As yet another implementation, the landmarks can be predefined characters or other types of objects within the input data, such as a new line character, a paragraph break, a page break, and so forth.

As noted above, embodiments of the invention can be applied to an environment that includes just one physical storage system 100. In such an environment, the compression-enhancing routing algorithm is performed at just one level, within the physical storage system 100. However, in environments with multiple physical storage systems 100, as shown in FIG. 1, another level of routing is provided to route data objects and requests to selected ones of the physical storage systems 100. The second level of routing (which is also a compression-enhancing routing algorithm) can be performed in one or more portals 120, or alternatively, in the client computers 122. Note that requests for accessing data objects in the system are submitted by the client computers 122. Portals 120 receive the requests from the client computers 122 over a network 124, and such requests are then routed over the network 102 to respective physical storage systems 100. In some embodiments, network 124 and network 102 may be the same network.

If the second level of routing is performed at the portal(s) 120, then the compression-enhancing routing algorithm can be implemented by a routing module 126 in each of the portal(s) 120. The routing module 126 is executable by one or more CPUs 128 in each portal 120. The CPU(s) 128 is (are) connected to a storage 130 in the portal 120.

Although multiple portals 120 are shown, it is noted that in an alternative implementation, just one portal 120 can be provided. In some embodiments, the portal(s) 120 is (are) not separate machines but is (are) subset(s) of the physical storage systems 100.

If the compression-enhancing routing algorithm is implemented in the client computers 122, each client computer 122 can include a routing module to perform the routing of requests.

In some embodiments, to batch requests against data stores, each physical storage system 100 provides an “inbox buffer” 140 for each data store 106 the physical storage system 100 contains. The inbox buffer 140 is a data structure that is stored in the persistent storage media 104 (or alternatively, in the temporary storage 108) for buffering requests (including write data if a request is a write request) received by the physical storage system 100 for a particular data store 106. In one embodiment, each inbox buffer 140 is a disk file that belongs to a corresponding data store 106. FIG. 1 shows multiple inbox buffers 140 for the corresponding multiple data stores 106.

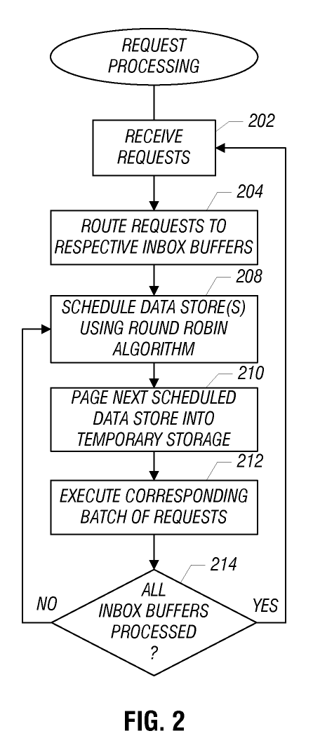

When a request is received by the physical storage system 100, the routing module 111 uses the compression-enhancing routing algorithm to route the request (including the write data if the request is a write request) to the corresponding inbox buffer 140. Each inbox buffer 140 effectively collects a batch of requests. As shown in the flow diagram of FIG. 2, requests are received (at 202) by the request execution module 112 of FIG. 1 and routed (at 204) to inbox buffers 140 of corresponding data stores 106 (using the compression-enhancing routing algorithm provided by the routing module 111 in the physical storage system 100). The received requests can include write requests, delete requests, and/or read requests. In some embodiments, steps 202 and 204 are interleaved, with requests routed as they arrive.

As noted above, if a received request is a write request, the write request can be either an update request or a store request. An update request will (indirectly) specify the data store that the update request is to be routed to, so the update request will be routed to the inbox corresponding to that specified data store. On the other hand, a store request will not specify a data store, but instead the routing algorithm will route the store request to one of the data stores (and thus the corresponding inbox buffer) according to where the compression-enhancing routing algorithm routes the accompanying new object.

In one embodiment, the compression-enhancing routing algorithm is a max-hash algorithm. With the max-hash algorithm, an incoming data object accompanying a store request is partitioned into multiple chunks, and hash values are computed for each of the chunks by applying a hashing function on the respective chunks. The max-hash routing algorithm chooses the hash with the maximum value (from among the multiple hashes computed for respective chunks of the data object) as the value to use for routing the data object to a particular one of multiple data stores. Thus, if two data objects share a chunk having a maximum hash value from among respective groups of chunks of the two data objects, then the two data objects are routed to the same data store. Further details regarding the max-hash routing algorithm are described in U.S. Patent Publication No. 2007/0250519.

In one embodiment, each data object accompanying a store request is assigned a name (c, k), where c is the name of the data store storing the data object, and k is the name returned by the data store for the data object. The value of c (name of a particular data store) is chosen by the routing algorithm based on the maximum hash value of the given data object. The name (c, k) of the data object is also referred to as its retrieval identifier (ID). To retrieve an object with name (c, k), the requester retrieves the data object with name k in data store c. In an alternative implementation, each data store may implement a scheme in which different data stores always assign different names to data objects, in which case the value of c can be omitted from the name of the data object. In this latter case, a requester may have to request the object from every data store, instead of just one data store, which adds to request traffic.

After various requests have been routed to respective inbox buffers 140, corresponding data stores 106 can be scheduled (at 208) for paging into the temporary storage 108. Scheduling can involve ordering a subset of the data stores for paging in or just deciding which data store to select to page in next. The next scheduled data store is paged in (at 210) into the temporary storage 108. The scheduling of data stores 106 to page into the temporary storage 108 can be based on a round robin technique, in which the data stores 106 are paged into the temporary storage 108 one after another. Alternatively, data stores can be paged into the temporary storage 108 using some other scheduling algorithm for scheduling paging in of data stores into the temporary storage 108. In some implementations, the selection of a data store to page into the temporary storage 108 can take into account which inbox buffers are full or almost full (e.g., 80% of capacity of the inbox buffer). An inbox buffer that is almost full can be given priority over another inbox buffer. In one implementation, just one data store 106 is paged into the temporary storage 108 at any one time. In a different implementation, if the data stores 106 are small enough and the available space of the temporary storage 108 is large enough, then multiple data stores 106 can be paged into the temporary storage 108 at one time.

After paging of the scheduled data store 106 into the temporary storage 108, the corresponding batch of requests (in a respective inbox buffer 140) is executed (at 212) against the paged in data store 106A. After each request is executed, it is removed from the inbox. Note that the respective data store associated with an update request can be determined based on its retrieval ID. The retrieval IDs of the update requests in each inbox share a common c value (as described above).

Note that a delete request can also specify a retrieval ID (as described above), from which the relevant data store can be determined.

Next, the request execution module 112 determines (at 214) whether any non-empty inbox buffers 140 remain. If not, another data store with a non-empty corresponding inbox is scheduled (at 208) for paging into the temporary storage 108. If no more non-empty inbox buffers 140 remain, then the process returns to receiving additional requests.

Although FIG. 2 shows the receiving/routing (202 and 204) and processing of inboxes (208-214) being performed in series, these can be done in parallel, with additional incoming requests being routed to inboxes (including possibly the inbox currently being processed) while requests are executed.

Under some embodiments, very large client objects may be split up into multiple smaller data store objects that may live in different data stores, either within the same physical storage system or across physical storage systems. Clients may refer to their objects using client IDs, which are mapped internally in the system to one or more data objects, each with a different retrieval ID. Client IDs may be assigned by the system or by the clients, depending on the embodiment. In the later case, clients may be able to use file pathnames as IDs. A “file pathname” refers to an identifier that is dependent upon the directory structure in which the file is stored.

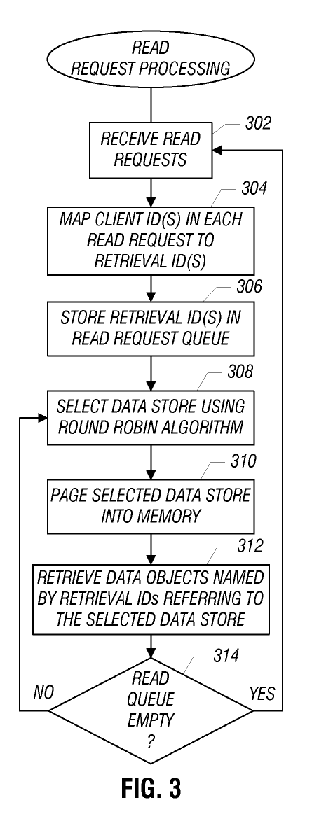

FIG. 3 shows processing of requests (such as read requests) according to an embodiment where large client objects are split up. Although the discussion of FIG. 3 refers to processing of only read requests, note that similar processing can be performed for other types of requests. Read requests are received (at 302) by the request execution module 112. To process read requests, a mapping data structure 142 (FIG. 1) can be maintained in the persistent storage media 104 to map (at 304) client IDs to corresponding one or more retrieval IDs. Here, it is assumed that client objects are not split across physical storage systems and thus entire read requests can be routed by a portal to a single physical storage system 100, which can then be the mapping locally via a local data structure 142. With other embodiments, client objects may be split across physical storage systems and thus the mapping data structure 142 should be located at the one or more portals and the mapping done there. In this case, the resulting retrieval IDs are routed to the appropriate physical storage systems' read queues.

As explained above, the name of a data store 106 can be determined from a retrieval ID. Using the mapping data structure 142, the client ID in a read request can easily be translated into a list of one or more retrieval IDs. The retrieval IDs of received read requests are stored (at 306) in a read queue 144 (FIG. 1). Although the discussion here describes the case where each read request asks for the contents of one client object, in some embodiments each request can name multiple client objects. Although steps 302 through 306 are shown as proceeding sequentially, in some embodiments they may be intermingled; for example, each request may be mapped and stored as soon as the request arrives.

Next, a data store is selected (at 308) that is referred to by one or more retrieval IDs in the read queue, and the selected data store is paged in (at 310) into the temporary storage 108. Next, the data objects named by the one or more retrieval IDs that refer to the selected data store are retrieved from the selected data store (at 312) and sent to the clients that (indirectly) requested those retrieval IDs. Those retrieval IDs are then removed from the read queue.

Next, if the read queue is not yet empty (at 314), the process loops back to step 308 to handle the remaining retrieval IDs. If the read queue is empty, the process proceeds back to step 302 to receive more read requests.

FIG. 3 shows the case where all requests are reads; if the system is also receiving write and delete requests, an additional step between 310 and 312 may be performed to apply any pending writes or deletes of data objects contained in the selected data store before step 312 reads from it. This prevents reads from returning stale data.

Although FIG. 3 shows the receiving/mapping/storing (302-306) and handling of retrieval IDs (308-314) being performed in series, these can be done in parallel, with additional incoming requests being mapped and stored while data objects are being retrieved.

If a read request (indirectly) specifies retrieval of only a single data object, then when the corresponding data store 106 is paged into the temporary storage 108 and the respective data object is read in from the paged in data store (at 312) and sent to the client, that request will be satisfied. In some designs, a client object may be spread across multiple data stores, which may involve paging in multiple data stores into the temporary storage 108 in turn in order to fully satisfy a read request for that client object.

If the read request is for multiple data objects, then the retrieval IDs associated with the multiple data objects are sorted by the data stores that the retrieval IDs refer to. Then, each data store is sequentially paged into the temporary storage 108 one at a time, such as by using a round-robin technique. The retrieval IDs can be batched such that when a particular data store 106 is paged into the temporary storage 108, then all respective data objects specified by the batch of retrieval IDs for that data store can be fetched from the data store that has been paged into the temporary storage. Note that this process can be performed in parallel across multiple physical storage systems, in which case the data stores are paged into the temporary storage 108 of multiple physical storage systems. Next, all desired the objects that reside within a particular data store that has been paged into the temporary storage 108 are fetched and returned to the requesting client computers 122.

In the read context, the “batching” of “requests” refers to batching of the retrieval IDs that are mapped from the read requests. A single read request can be mapped to one or more retrieval IDs, and the retrieval ID(s) can then be collected into one or more batches for execution against data stores to be paged into the temporary storage 108. Using this technique, each data store is paged into temporary storage 108 at most once to process a group of read requests, which provides much better retrieval performance.

Note that not all data stores for satisfying all pending read requests may fit within the temporary storage 108; that is, there may not be room in the temporary storage 108 to fully page in all of those data stores. In this case, the data stores are paged in as sets into the temporary storage 108. First, a first set of data stores are paged into the temporary storage 108, and the reads for accessing the data stores in the first set are executed. Next, a second set of data stores replaces the first set of data stores in the temporary storage 108, and the reads for accessing the data stores in the second set are executed.

Note that objects provided back to a requesting client computer 122 in response to read requests can appear to the client computer as being in some random order (rather than in the order of the requests issued by the client computer). The client computer 122 can be configured to properly handle objects that are received in an order different from the order of requests. For example, the client computer 122 can first create all relevant directories using information of the mapping data structure, and then store objects as they arrive in the directories.

In alternative embodiments, instead of running the various tasks noted above in a single physical storage system 100, those tasks can also be run on a cluster of physical storage systems 100 (such as the plural storage systems 100 depicted in FIG. 1). In this case, two levels of routing can be used. The first routing determines which physical machine to send the requests to, and a second routing determines which data store on that machine to route to.

If the cluster of computers share disk storage (e.g., any physical storage system can access any disk block), then some additional possibilities exist. In particular, any physical machine can page in any data store (modulo a data store cannot be paged into two physical machines at the same time). This allows for greater fault tolerance (fewer machines just means that paging in every data store takes longer) and better load-balancing (with an idle machine chosen rather than being forced to wait for a particular machine to be finished).

Another variation involves using smaller data stores so that a single physical machine can page in more than one data store at a time into the temporary storage 108. Using more data stores slows down processing, but allows easier load-balancing and fault tolerance.

Instructions of software described above (including the request execution module 112, routing module 111, and deduplication module 113 of FIG. 1) are loaded for execution on a processor (such as one or more CPUs 110 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method, comprising:
selectively storing data objects across a plurality of differential data stores, wherein selection of the differential data stores for storing respective data objects is according to a criterion relating to compression of the data objects in each of the data stores, and wherein the differential data stores are stored in persistent storage media;
batching plural requests for accessing at least one of the differential data stores;
selecting one of the differential data stores to page into temporary storage from the persistent storage media; and
executing the batched plural requests for accessing the selected differential data store that has been paged into the temporary storage.

2. The method of claim 1, further comprising storing the plurality of differential data stores in the persistent storage media of one physical storage system.

3. The method of claim 1, further comprising providing multiple physical storage systems, wherein the persistent storage media are located in the multiple physical storage systems, wherein at least one of the physical storage systems includes multiple ones of the plurality of differential data stores.

4. The method of claim 3, further comprising:
routing the plural requests to selected ones of the multiple physical storage systems using a routing algorithm to enhance compression of data objects in the data stores; and
performing routing, in a particular one of the selected ones of the multiple physical storage systems, of requests received by the particular physical storage system to selected ones of the multiple differential data stores stored in the persistent storage media of the particular physical storage system to enhance compression of data objects stored in the data stores stored in the persistent storage media of the particular physical storage system.

5. The method of claim 1, wherein at least some of the plural requests comprise write requests, the method further comprising:
writing data objects associated with the write requests for accessing the selected differential data store into the selected differential data store that has been paged into the temporary storage.

6. The method of claim 1, wherein at least some of the plural requests comprise read requests, the method further comprising:
sorting the read requests according to differential data stores to be accessed by the respective read requests; and
paging a first set of the differential data stores from the persistent storage media into the temporary storage, wherein the sorted read requests for accessing the differential data stores in the first set are satisfied from the first set of the differential data stores while they are in the temporary storage.

7. The method of claim 6, further comprising replacing in the temporary storage the first set of the differential data stores with a second set of differential data stores, wherein the sorted read requests for accessing the differential data stores in the second set are satisfied from the second set of differential data stores while they are in the temporary storage.

8. The method of claim 6, wherein the read requests are received from one or more clients, the method further comprising:
responding to the received read requests with responsive data objects read from the differential data stores in an order different from an order in which the read requests are received.

9. The method of claim 6, wherein each read request includes an identifier of a file, the method further comprising:
translating the identifier of the file into one or more retrieval identifiers, wherein each of the retrieval identifiers identifies a respective data store.

10. The method of claim 9, wherein the differential data stores use chunk-based deduplication.

11. A storage system comprising:
a temporary storage;
a persistent storage to store a plurality of differential data stores;
a processor to:
receive requests to access differential data stores;
route the requests using a routing algorithm to the differential data stores, wherein the routing algorithm is to enhance compression of data objects stored in each of the differential data stores;
collect at least one group of the received requests;
select one of the differential data stores to page from the persistent storage into the temporary storage; and
execute the group of requests for accessing the selected differential data store that has been paged into the temporary storage.

12. The storage system of claim 11, wherein the processor is to further perform chunk-based deduplication in the differential data stores.

13. The storage system of claim 11, wherein the received requests include write requests, the storage system further comprising inbox buffers associated with corresponding ones of the differential data stores,
wherein the processor is to further:
route the write requests into respective inbox buffers to collect respective batches of the write requests; and
execute write requests in a corresponding one of the inbox buffers against the differential data store paged into the temporary storage.

14. The storage system of claim 13, wherein the received requests further include delete requests, and
wherein the processor is to further:
route the delete requests into respective inbox buffers; and
execute the delete requests in a corresponding one of the inbox buffers against the selected differential store paged into the temporary storage.

15. The storage system of claim 11, wherein the received requests include read requests, and
wherein the processor is to further:
map a file identifier in each of the read requests into corresponding retrieval identifiers that each identify a corresponding differential data store; and
sort the retrieval identifiers according to respective differential data stores,
wherein the sorted read requests are collected into the at least one group.

16. A system comprising:
a plurality of storage systems, wherein each of the storage systems includes persistent storage, wherein the persistent storage of at least a first one of the storage systems is to store a plurality of differential data stores, wherein the storage systems are to receive requests issued by one or more client computers, and wherein the requests are routed to corresponding one or more of the storage systems,
wherein the first storage system includes a temporary storage and a processor to collect requests received by the first storage system into one or more groups, and the processor is to select the differential data stores according to a scheduling algorithm to page into the temporary storage, and to execute one of the one or more groups of requests against a first differential data store paged into the temporary storage.

17. The system of claim 16, further comprising a portal that includes a routing module to perform a compression-enhancing routing algorithm when routing requests to the storage systems to enhance compression of data stored in the respective storage systems.

18. The system of claim 16, wherein the processor of the first storage system employs a routing algorithm when routing requests to corresponding differential data stores to enhance compression of data stored in the differential data stores contained in the first storage system.
